(19) United States
(12) Patent Application Publication
(10) Pub. No.: US 2007/0140701 A1
(43) Pub. Date: Jun. 21, 2007

(54) Optical signal polarisation control method and controller device

(76) Inventor: Benedetto Riposati, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/585,066

(22) PCT Filed: Dec. 31, 2003
(86) PCT No.: PCT/IT03/00868

§ 371 Date: Jun. 29, 2006

(51) Int. Cl. H04B 10/00

(52) U.S. Cl. 398/152

(57) ABSTRACT

A polarisation control method includes the steps of feeding an optical input signal to a first polarisation transformation block for providing a corresponding first optical output signal; feeding the first optical output signal to a second for providing a corresponding second output signal; providing to the blocks, regulating signals which are variable within limited time intervals and adapted to induce the blocks to assume a configuration wherein the second block is in an active state and the first block is in a reset state in order to carry out a rewind operation wherein the corresponding regulating signal is induced to assume a value within the corresponding limited interval.

The present invention relates to optical signal polarisation control methods.

In the field of optics, it is frequently necessary to perform a control of the state of polarisation (SOP) of signals. In particular, in many types of optical telecommunication systems, based on propagation in free space or on guided propagation, variations or oscillations in the state of polarisation may represent an undesirable source of noise.

Polarisation controller devices using optical elements which are able to introduce variable transformations in the polarisation of optical input signals, and are controlled through appropriate regulating signals are known. Typically such signals are generated by feedback circuits, sensitive to the polarisation of the output signal.

A problem shown by such controller devices is related to the fact that the polarisation of the input signal may vary monotonically and for long periods of time, thus bringing the regulating signal to the attainment of a limit value which is dependent on the physical limits intrinsic to the optical elements used in order to introduce the polarisation transformation. In general, upon reaching such a limit value, polarisation control is interrupted.

Controller devices for which it has been attempted to achieve a relatively continuous polarisation control (i.e., without interruptions) are known. Such control devices envisage a reset or restoration operation which allows returning the regulating signal, which has reached the limit, to a value which is useful for polarisation control. These types of devices are known by the term “end-less devices, with reset procedure”.

An aspect of primary importance for the control performances carried out by such end-less devices with reset procedure is associated with how much the reset procedure penalises the continuity of the polarisation control itself.

U.S. Pat. No. 5,004,312 describes a polarisation controller device which provides a reset procedure and which uses five optical phase modulators, connected in series and such that their principal axes of birefringence are in directions of 0°, 45°, 0°, 45° and 0° with respect to a horizontal line which lies on a surface perpendicular to the direction of propagation of the light. The five phase modulators are arranged such that the first modulator is found at the entry and the fifth is at the exit of the path of the optical signal to be controlled. During operation, for carrying out the polarisation transformation necessary for control, the second, third and fourth phase modulators are used. During the reset of the second phase modulator, the third, fourth and fifth phase modulators are used for the control of the fluctuations in polarisation. During the reset of the third phase modulator, the second, fourth and fifth phase modulators are used for the control of the fluctuations in polarisation. During the reset of the fourth phase modulator, the first, second and third phase modulators are used for the control of the fluctuations in polarisation. The Applicant observes that this patent does not illustrate the operation of the device proposed in the case of the reset of the first and the fifth phase modulators.

U.S. Pat. No. 4,979,235 describes a polarisation controller of the type using a reset procedure which comprises three liquid crystal variable optical delay units for the control of the polarisation of an optical signal generated by a local source.

Patent application US-A-2002/0191265 describes a feedback and end-less type polarisation transformer. This polarisation transformer comprises two transformer stages including waveplates optically connected in series. The two polarisation transformation stages are intended to operate intervals of variation of different polarisation amplitudes. According to that stated in this document, the proposed device does not require any reset procedure.

The article “Endless polarization state matching control experiment using two controllers of finite control range” by C. J. Mahon and G. D. Khoe, published in Electronics Letters of 5 Nov. 1987, Vol. 23, No 23, describes an experimental apparatus for the control of polarisation by homodyne and heterodyne receivers which makes use of a quarter waveplate followed by two polarisation controllers in series, achieved by using two piezoelectric squeezers. In such article, it is asserted that only the controller device which is furthest from the quarter waveplate occasionally requires a reset procedure.

The Applicant has observed that the endless type devices capable of controlling polarisation, described in the above cited documents, require complicated control systems.

The Applicant has addressed the problem of devising both a method and an end-less type polarisation control device with reset procedure, which are non complex in implementation and which offer satisfactory performances.

The Applicant has found that the above mentioned problem may be resolved by providing two distinct polarisation transformation blocks connected optically in series, each achieved in such a manner as to allow introducing the variations in polarisation which are necessary for the specific polarisation control desired. To such transformation blocks are sent regulating signals which activate only one of the two blocks for polarisation control and, such control is transferred to the other block when the activated one must initiate a reset procedure.

In particular, the Applicant has observed that the inventive method has the advantage of ensuring efficient polarisation control even during reset procedures of one of the two blocks. Furthermore, the inventive method allows the realisation of non complex polarisation control devices which do not require particularly onerous optical element alignment operations.

A polarisation control method as defined by the enclosed claim 1 is an object of the present invention. Preferred embodiments of the method are defined by the enclosed claims 2 to 10.

Furthermore, a polarisation controller device as defined by claim 11 also is an object of the invention. Preferred embodiments of such a device are described in claims 12 to 23. The present invention also relates to a controlled polarisation system as described by the enclosed claim 24, whilst claims 25 to 34 relate to preferred embodiments of the system.

Further characteristics and the advantages of the invention will emerge following the description made with reference to the enclosed indicative and non limiting drawings, in which:

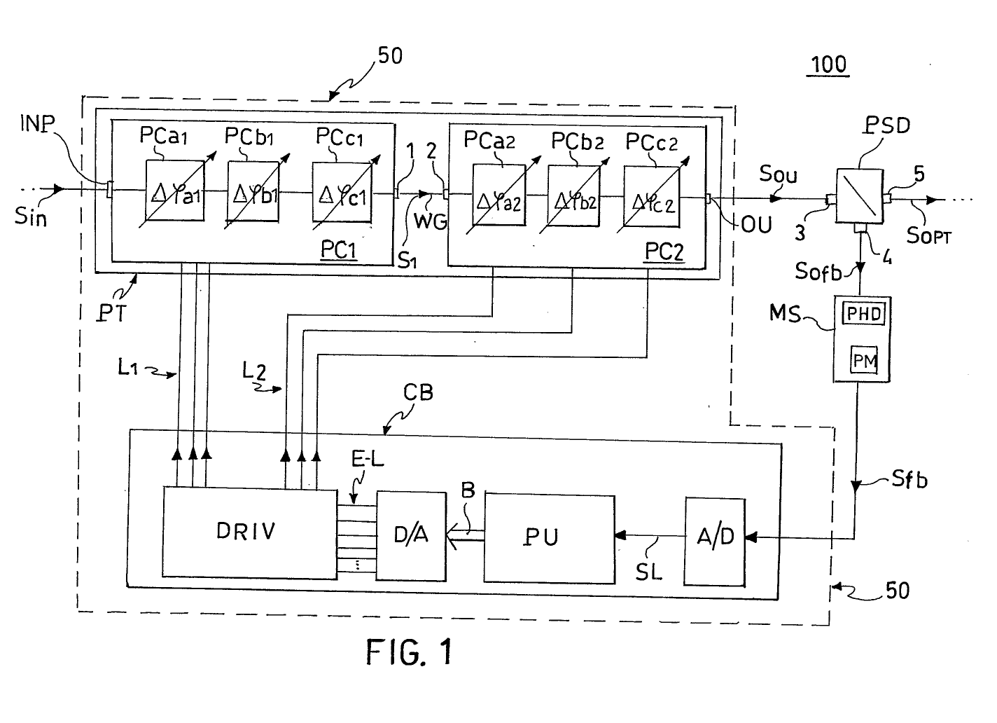

FIG. 1 shows by using functional blocks an exemplificative embodiment of a polarisation controller device inserted within a feedback type controlled polarisation system, in accordance with one particular application of the invention;

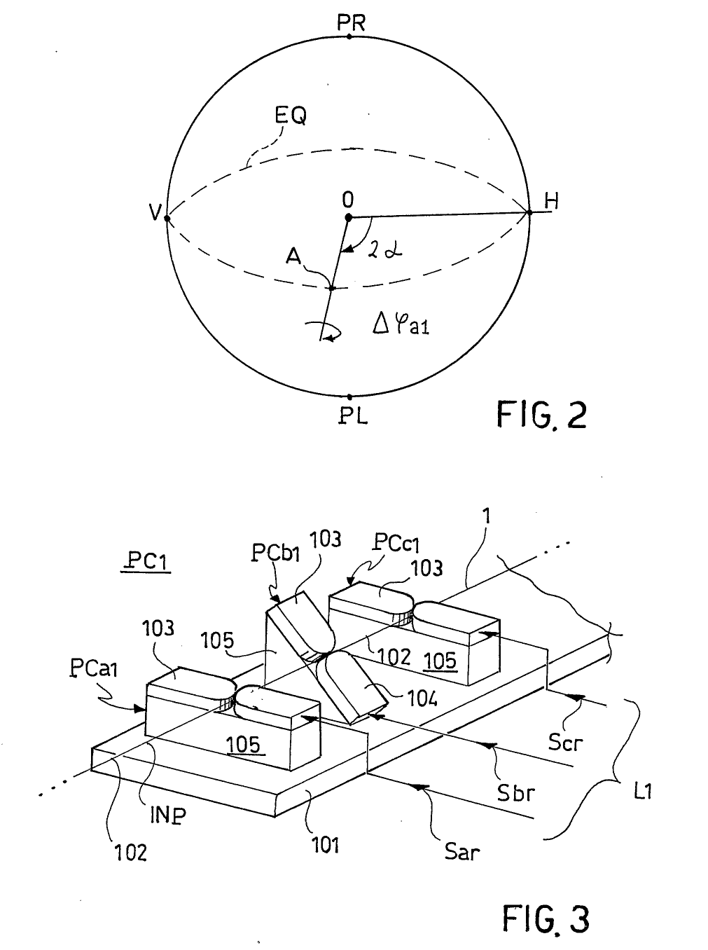

FIG. 2 shows a method of operation of a polarisation converter element, utilisable in said device, on the Poincaré Sphere;

FIG. 3 shows an example of a polarisation transformation block comprising fibre optic squeezers utilisable in said device;

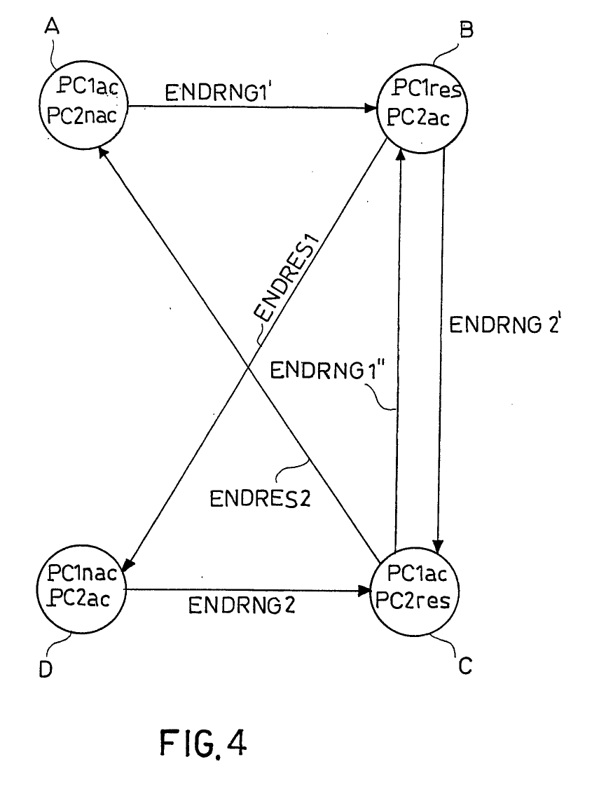

FIG. 4 shows a possible transition diagram between different operative configurations corresponding to one operational example of said device,

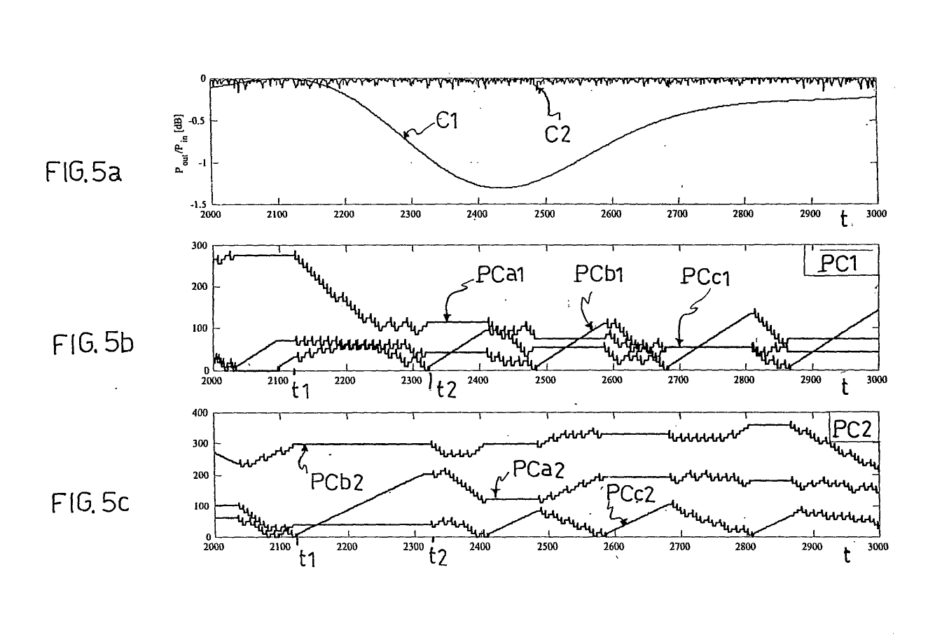

FIGS. 5A, 5B and 5C show the behaviour of signals obtained from a computer simulation aimed at testing the performance of a controller device analogous to that of FIG. 1;

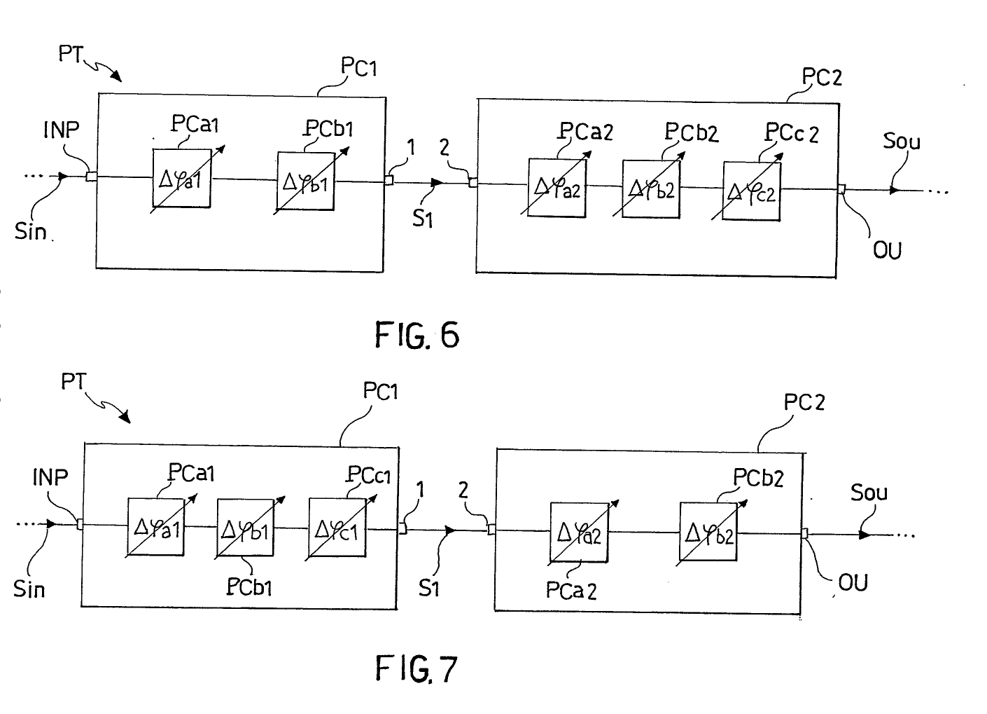

FIG. 6 and FIG. 7 show alternative embodiments of a polarisation transformer for use within said controller device;

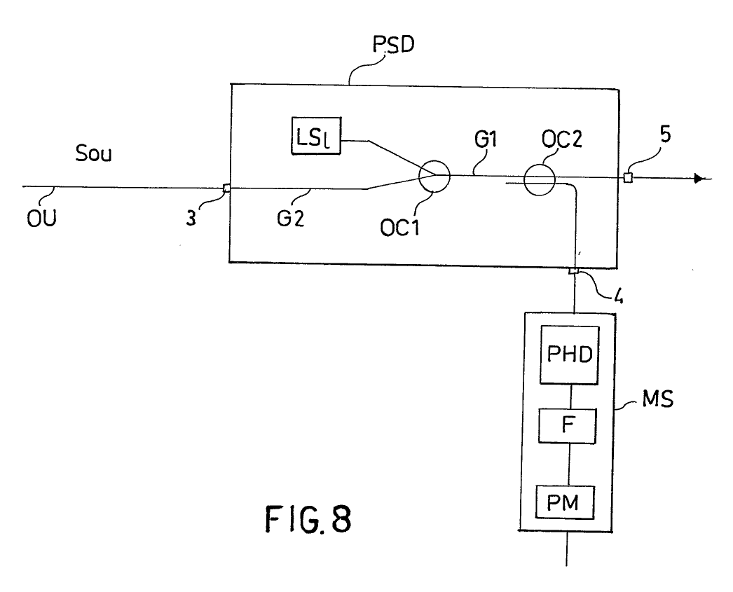

FIG. 8 schematically shows a device sensitive to polarisation for use within said controlled system in order to bring about coherent reception.

For the purposes of the present invention, by the term “polarisation” of an optical signal is meant the state of polarisation (SOP) assumed by the electromagnetic radiation associated with the optical signal. Thus, in the following of the present description the terms “polarisation” and “state of polarisation” are to be understood as equivalent.

Furthermore, for the purposes of the present invention a polarisation transformation or conversion device is defined “any-to-any” when it is of such a type as to carry out transformations of the polarisation of an optical input signal, having polarisation which may vary between all the possible states of polarisation, into an output optical signal having polarisation which may vary between all the possible states of polarisation. A polarisation transformation or conversion device or block of an optical input signal is defined as “fix-to-any” when it is of such a type as to carry out polarisation transformations of an optical input signal having a fixed polarisation (i.e. substantially constant over time) into an optical output signal having a polarisation which may vary between all the possible states of polarisation.

A polarisation transformation or conversion device is defined as “any-to-fix” when it is of such a type as to carry out transformations of the polarisation of an optical input signal, having a polarisation which may vary between all the possible states of polarisation, into an output optical signal having a fixed polarisation (i.e. substantially constant over time). The any-to-any, fix-to-any and any-to-fix type polarisation transformations or conversions are defined in an analogous manner.

In FIG. 1 is shown schematically one particular example of a polarisation controller device 50, in accordance with the invention, and including a polarisation transformer PT and a control and processing stage CB. According to the particular example illustrated in FIG. 1, the controller device 50 is inserted into a feedback type controlled polarisation system 100, comprising, in addition, a polarisation sensitive device PSD coupled to a measuring device MS connected to the control and processing stage CB.

The controlled system 100 is of such a type as to carry out polarisation transformations of an optical input signal Sin in such a manner as to follow the desired polarisation of an optical output signal Sopt.

The controller device 50 is equipped with a first input INP for receiving the optical input signal Sin having a first state of polarisation SOPin and provide over a second output OU a second optical output signal Sou having a second state of polarisation SOPout, obtained by a modification carried out in a controlled manner of the state of polarisation of the optical input signal Sin. According to this first exemplificative embodiment of the invention, the controller device 50 is of any-to-any type i.e. it is of such a type as to modify any state of polarisation SOPin of the optical input signal Sin into any state of polarisation SOPout of the second optical output signal Sou. In other words, as it is clear from the definitions reported above, the controller device 50 is able to operate with an optical input signal Sin which may assume, over time, any from amongst all the possible states of polarisation and provide a corresponding second optical output signal Sou which may assume, over time, any from amongst all the possible states of polarisation.

In greater detail, the polarisation transformer PT comprises a first polarisation transformation block PC1, having an input which is coincident with the first input INP of the controller device 50 and a corresponding first output 1. Furthermore, the polarisation transformer PT comprises a second polarisation transformation block PC2 (distinct from the first block PC1) having a second input 2, optically coupled to the first output 1 and a corresponding output, which, in the representation of FIG. 1, coincides with the second output OU of the controller device 50. The first PC1 and the second block PC2 are optically coupled through an optical path WG such as, for example, an integrated waveguide on a chip or a fibre optic, or a non-guided path, for example, in free space. According to the particular example under consideration, the optical path WG is of such a type as to introduce negligible and/or substantially unchanging polarisation variations over time.

The first and second polarisation transformation blocks PC1 and PC2 are connected in series and, for example, each includes at least two polarisation converter elements, in turn, connected in series. Furthermore, the first PC1 and the second PC2 transformation blocks are distinct from one another in that they do not contain any polarisation converter elements in common. According to the particular example described wherein the controller device 50 is of the any-to-any type, both the first PC1, and the second PC2 blocks are each any-to-any transformation blocks. In particular, as will also be specified later, the two transformation blocks PC1 and PC2 are of the non endless type and envisage reset procedures.

Advantageously, each of such transformation blocks PC1 and PC2, includes three polarisation converter elements. In particular, the first transformation block PC1 comprises first PCa1, second PCb1 and third PCc1 polarisation converter elements, optically connected in series. In particular, the first transformation block PC1 comprises first PCa1, second PCb1 and third PCc1 polarisation converter elements, optically connected in series. Within each block PC1 and PC2, the polarisation converter elements PCa1-PCc2 are connected to one another by optical paths, for which the same considerations as for optical path WG are valid.

Each of such polarisation converter elements PCa1-PCc2 allows the conversion, i.e. transformation, of an optical input signal having a first state of polarisation SOP, into an optical output signal having a different state of polarisation SOP′. Furthermore, the polarisation conversion introduced by each polarisation converter element PCa1-PCc2 is of a variable extent i.e., adjustable, by using appropriate regulating signals.

According to one preferred embodiment of the invention, both the polarisation converter elements of the first transformation block PC1, and those of the second block PC2 are obtained using elements having fixed principal birefringence axis and variable birefringence. As it is known, the principal birefringence axis of a propagation means is one of the axes of the means along which electromagnetic radiation, having a linear polarisation aligned with this axis does not undergo any polarisation transformations, but is propagated, maintaining the initial polarisation.

In general, the birefringence of a means wherein electromagnetic radiation is propagated is proportional to the difference between the refractive indices along the two main axes of birefringence.

The electrical field E̅ associated with the electromagnetic radiation which is propagated within the means along a direction z, may be represented by two of its components, Ex and Ey, perpendicular to one another and normal to the axis z, each representable by an amplitude and a phase. If the propagation means has a non null birefringence, the two components Ex and Ey of the electrical field E̅, whilst being propagated within the means under consideration, undergo different phase delays. Hence, in crossing the means of propagation, components Ex and Ey are phase shifted by an amount Δφ which is proportional to the birefringence. This displacement Δφ between the phases of components Ex and Ey of the electrical field E̅, due to propagation within the birefringent means, corresponds to a transformation of the input polarisation of the electromagnetic radiation.

In particular, with reference to the well known representation of polarisation on the Poincaré Sphere, the aforesaid transformation corresponds to a rotation of an angle Δφ of the state of polarisation SOP of the input radiation around the axis of the equatorial plane which represents the horizontal and vertical polarisations within the Poincaré Sphere.

Therefore, for each of the birefringent elements PCa1-PCc2, the possibility of varying the birefringence makes regulation of angle Δφ possible and i.e. allows for the variation or modulation of the final amount of polarisation rotation induced by the birefringent element itself.

In FIG. 1, for each converter element PCa1-PCc2, the corresponding polarisation rotation values which each element is able to introduce, are indicated by Δφa1-Δφc2.

Preferably, in each of the two transformation blocks PC1 and PC2, the polarisation converter elements PCa1-PCc2 are oriented in such a manner that the corresponding principal birefringence axes of two consecutive elements identify a preset angle, in particular, substantially equal to 45°.

For example, with reference to the first transformation block PC1, the first variable birefringence element PCa1 shows a principal birefringence axis having any angle α estimated with respect to a reference direction lying within the plane perpendicular to the direction z of propagation of the radiation. The second element PCb1 shows a principal birefringence axis having an angle equal to α±45°. The third variable birefringence element PCc1 shows a principal birefringence axis again having an angle equal to α.

Analogously, the variable birefringence elements PCa2, PCb2 and PCc2 of the second transformation block PC2 show principal axes of birefringence having angles respectively equal to: β, β±45° and β. It is observed that the angle β may be equal to α or may have any other value which may be selected in an entirely independent manner from the specific value of angle α.

In order to describe the mode of operation of each of the variable birefringence converter elements PCa1-PCc2 it is convenient to make reference to the Poincaré Sphere, represented in FIG. 2. The equator EQ of the Poincaré Sphere represents the linear states of polarisation, the poles PR and PL represent the right and left circular states of polarisation and the points of the Sphere distributed between the equator and the poles represent the elliptical polarisations. Points H and V represent, respectively, the horizontal and vertical linear states of polarisation.

The first birefringence element PCa1, the principal birefringence axis OA of which is identified on the Poincaré Sphere by the angle 2a estimated with respect to the passing axis of point H and from the centre O of the Sphere, should be considered. The effect of such first element on the polarisation is a rotation Δφa1 around the axis OA.

As one skilled in the art will recognise, the presence of three variable birefringence elements with the above indicated relative orientations, in each of the polarisation transformation blocks PC1 and PC2, allows each of these blocks to perform an any-to-any transformation.

In other words, both the first transformation block PC1, and the second transformation block PC2 allow the conversion of any point on the Poincaré Sphere into any other point of the Sphere itself. The use of three variable birefringence elements, and not just two variable birefringence elements, ensures the achievability of any-to-any transformations even when the input signal within the transformation block (for example, the second block PC2) assumes such a state of polarisation for which the first variable birefringence element of the block (for example, element PCa2) is not able to induce any rotation of polarisation.

Indeed, it is possible that the state of polarisation of the input signal is such that, due to the particular orientation of the principal axis of birefringence of the first variable birefringence element PCa2, this latter leaves the polarisation unchanged. In one such situation, the second variable birefringence element (i.e., according to the example, element PCb2), oriented in a different manner than that of the first element PCa2, is certainly able to modify the state of polarisation. The third variable birefringence element PCc2 will carry out the omitted rotation for the achievement of whatsoever output state of polarisation.

As already mentioned, each of the two polarisation transformation blocks PC1 and PC2 is intrinsically of the non end-less type with reset procedure (hereinafter also denominated, restoration or rewind procedure). By the term non end-less is meant that the polarisation transformation block under consideration is such whereby, in the case of particular variations in the polarisation of the input signal (for example, when this varies monotonically for a long period of time) reaching a limit (depending on the optical components which constitute it) beyond which it is not able to operate and hence interrupts matching of the variation of polarisation upon input. The rewind procedure envisages that the control and processing stage CB acts on the polarisation transformation blocks which have interrupted matching in such a manner as to return the block itself to operating conditions which are sufficiently far a way from the limit reached.

Referring back to the description of the controlled system 100, the second output OU is optically coupled to an input port 3 of the polarisation sensitive device PSD which, in turn, is equipped with at least one first output port 4. The polarisation sensitive device PSD is of such a type as to provide, over the first output port 4, an optical feedback signal Sofb which is dependent on the state of polarisation of its input signal (in this specific case, the second optical output signal Sou). The optical feedback signal Sofb has at least one characteristic quantity (such as, the power associated with it) which is dependent on the state of polarisation of the second optical output signal Sou present at the input port 3 of the polarisation sensitive device PSD.

According to one particular exemplificative embodiment of the invention, to which reference will be made in the following unless otherwise specified, the polarisation sensitive device PSD is a polarization beam splitter of the type known and equipped, additionally, with a second output port 5.

The polarisation beam splitter PSD is adapted to sending over the second output port 5, that portion of the second optical output signal Sou having polarisation components aligned with a state of polarisation SOPp (for example, linear) which characterises the splitter itself. Furthermore, the polarisation beam splitter PSD is of such a type as to send over the first output port 4 that part of the optical signal Sou present at its input and having a state of polarisation which is different from that of SOPp which characterises the splitter and, in particular, perpendicular to it. Alternatively to the polarisation splitter PSD a polariser may be used such as to select a prefixed polarisation (i.e., such as to transmit as output only the part of the second output signal having a preset polarisation), followed by an optical coupler (not shown) such as to send over the first output port 4 and over the second output port 5 parts of the power of the selected signal emerging from the polariser.

The first output port 4 of the polarisation sensitive device PSD is optically coupled to a measuring device MS. According to the described example, the measuring device MS allows carrying out the conversion of an optical signal received from the polarisation splitter PSD into an analogue electrical feedback signal Sfb having a parameter (for example, the electrical current or voltage) which is correlated with the power of the optical signal present over the first output port 4. Such electrical feedback signal Sfb is indicative of the sate of polarisation of the signal present over the second output OU.

According to a particular embodiment of the invention, the measuring device MS comprises a photo-detector PHD (such as, for example, a conventional photodiode) for converting the electromagnetic radiation into an analogue electrical signal. Preferably, the measuring device MS comprises a power meter PM in order to receive the analogue electrical signal provided by the photo-detector PHD and return an analogue electrical feedback signal Sfb, representative of the electrical power associated with the signal emerging from the photo-detector.

The processing control stage CB comprises an analogue-digital A/D converter, realisable in a conventional manner, and of such a type as to convert the analogue electrical feedback signal Sfb into digital data, making it available over a digital line SL. Such a digital line SL, emerging from the analogue-digital A/D converter, is connected to a processing and control unit PU which has the function of processing the digital data received and determining digital regulating signals, to be sent over a plurality of output lines, generally indicated by B.

The plurality of output lines B is connected to corresponding single conversion stage digital-analogue converters D/A in order to convert the digital regulating signals into corresponding analogue signals to be made available over electrical lines E-L.

The processing and control unit PU may be made, for example, by a microprocessor, a microcontroller or, preferably, by a conventional programmable logic card FPGA (Field Programmable Gate Array). The processing unit PU may also be equipped with a memory (not shown) for the storage of data. Within such a memory may be stored instructions corresponding to a program for the processor which allows the implementation of the method of operation in accordance with the invention.

The electrical lines E-L are connected to a drive stage DRIV of such a type as to provide to the first and second polarisation transformation blocks PC1 and PC2 regulating signals with amplitude commensurate with their operating conditions. Advantageously, the drive stage DRIV may also have an amplification function for the signals present over the electrical lines E-L. The drive stage DRIV is connected to the first and second transformation blocks PC1 and PC2 through corresponding conductive output lines L1 and L2 for the corresponding regulating signals. As will be further clarified below, the regulating signals impose the desired polarisation rotation of each variable birefringence element PCa1-PCc2 and allow the adjustment of the controller device 100 into the different operational configurations. For example, such regulating signals are electrical voltage signals.

With reference to the creation of the polarisation transformation blocks PC1 and PC2, each variable birefringence converter element PCa1-PCc2 is realisable, preferably, by using a corresponding fibre optic “squeezer”, in itself entirely conventional. FIG. 3 shows one example of the first transformation block PC1 including a support plate 101 onto which the variable birefringence elements PCa1, PCb1 and PCc1, achieved by using the corresponding squeezers, are fixed. Each of such variable birefringence elements includes a corresponding length of fibre optic 102 (for example, a monomodal fibre) which extends between the first input INP and the first output 1 of the transformation block PC1. Furthermore, each of the variable birefringence elements comprises a pair of piezoelectric actuators 103 and 104 so as to exercise adjustable pressure on the corresponding length of fibre optic 101 in such a manner as to induce birefringence. The piezo-electric actuators 103 and 104 are mounted on corresponding support frames 105 fixed to the base plate 101. Such support frames 105 are made in such a manner as to orient the actuators 103 and 104 with an appropriate inclination with respect to the direction of the axis of propagation of the fibre optic 102, in accordance with that mentioned above in relation to the inclination of the principal birefringence axes of the variable birefringence elements. The support frames, realisable, for example in stainless steel, are electrically connected through the plurality of conductive output lines L1 (in this case, three conductive lines) to the drive stage DRIV. The conductive output lines L1 allow the sending of the corresponding regulating signals Sar, Sbr and Scr (which assume the form of electrical voltage signals) to the corresponding converter elements PCa1-PCc1.

The second transformation block PC2 may be mounted on the same support plate 101 and be obtained in an analogous manner to the first transformation block PC1. Transformation blocks which are suitable for the realisation of the two blocks PC1 and PC2, of the type which are made by using squeezers, are included within conventional type polarisation controller devices and are commercially available, for example, those in the Polarite II polarisation controllers, manufactured by General Photonics Corporation, USA.

Alternatively to the use of squeezers for the realisation of the variable birefringence elements Pca1-PCc1, other polarisation converter elements, known to those skilled in the art, may be used such as, for example, liquid crystal plates which operate on the basis of an electro-optic effect produced from the electrical voltage signals applied to them.

It is observed that, according to one additional embodiment of the invention, alternative to those described above, the polarisation transformation blocks may instead include variable birefringence elements with fixed principal axis of birefringence or in addition to these, fixed birefringence elements with a variable principal axis of birefringence. For example, rotating quarter wave plates or half wave plates, which have, as it is known, variable and fixed principal axes of birefringence may be used.

It should be remembered that each of the variable birefringence elements PCa1-PCc2, both of the type using squeezers or the type made using other feasible technologies, is representable using the following Jones matrix:

$$[ \begin{matrix}1 & 0 \\ 0 & {ⅇ}^{- jΔφ}\end{matrix} ]$$

wherein the value Δφ, proportional to the birefringence, represents the overall delay accumulated in propagation within the variable birefringence element and is a function of the electrical voltage V of the regulating signal of the element itself:
Δφ=f(V)

Function f(V) assumes the following form:
f(V)≈(V/Vπ)π
wherein Vπ is the voltage to be applied to the variable birefringence element so that the input polarisation is rotated by 180° on the Poincaré Sphere.

The voltage variation interval V is limited and is comprised between two limit values (for example, it is comprised of between 0 and 2-3 times the value Vπ). Hence, reaching a limit voltage value is possible, as a consequence of which, there is an interruption in matching by the individual variable birefringence converter element.

Upon reaching the limit voltage it is necessary to perform the variable birefringence element reset or rewind procedure, returning the regulating voltage V to a value which is non coincident with the limit values and i.e. to a value within the regulating voltage variation interval. For example, during rewind, the voltage is returned to a mid point value of the regulating voltage V variation interval.

With respect to the operation of the polarisation controller device 50, it is observed that this operates by using only the first polarisation transformation block PC1 or only the second polarisation transformation block PC2, alternatively. In greater detail, each of the transformation blocks PC1 and PC2 may assume the following three different operating states: an active state, a non-inactive state and a refresh state (henceforth also denominated rewind state).

In order to clarify the meaning of the individual states, reference will be made solely to the first transformation block PC1, but analogous considerations are valid for the second transformation block PC2.

The first transformation block PC1 is in the active state when the processing control stage CB sends, over the output conductive lines L1, at least one regulating signal (for example, a voltage signal sent to a variable birefringence element) adapted to vary over time according to a particular control criterion. This possible variation in the regulating signals makes the polarisation transformation carried out by the first transformation block PC1, variable over time. According to the example relating to the feedback type controlled system 100, when the first transformation block PC1 is in the active state, it carries out the matching of the state of polarisation of the second optical output signal Sou in accordance with the pre-established control criteria and, in particular, on the basis of the optical feedback signal S_{ofb}.

The first transformation block PC1 is in the inactive state when all the corresponding regulating signals produced by the control and processing stage CB assume substantially constant values and hence the block itself introduces a polarisation transformation (due to the presence of the birefringence elements PCa1-PCc1) which is substantially constant over time. With reference to the particular example of a feedback type controlled system 100, when the first transformation block PC1 is in the inactive state, it does not participate in matching the state of polarisation of the second optical output signal Sou according to the pre-arranged control criteria. In this case, for example, the regulating signal which brings about the resetting of the operating conditions of one of the converter elements Pca1-PCc1 varies over time, in a manner which is independent from the electrical feedback signal S_{fb}. It is observed, for example, that in spite of the fact that the regulating signals assume constant values whilst in the active state, it is possible that the polarisation converter elements of one of the blocks PC1 or PC2, due to the phenomena of undesired noise (for example, thermal drift), can bring about polarisation transformations that are not completely constant but are slightly variable over time. Typically, such undesired variations in polarisation transformation are slow and introduce negligible rotations in the polarisation, i.e., less than around 5° or about 2° on the Poincaré Sphere.

The first transformation block PC1 is in the reset state when the control and processing stage CB returns at least one of the regulating signals of the block itself to within the limited interval between which this may vary. I.e., a regulating signal is brought to assume values which do not coincide with the limit values of such interval. For example, the first transformation block PC1 is in the reset state when the above described rewind procedure of one or more of the variable birefringence elements PCa1-PCc1 occurs. The reset state is subsequent to the reaching of the corresponding limit value by one of the regulating signals. Furthermore, the control and processing stage CB generates regulating signals, the behaviour of which allows bringing the controller device 50 overall, to assume four alternative operating configurations.

FIG. 4 shows a graph of the operating configurations wherein these are indicated by the letters A, B, C and D. The states assumed by the two transformation blocks PC1 and PC2 for each operating configuration are represented by the reference which indicates the particular block (PC1 or PC2) followed by the symbols “ac”, “nac” and “res”, representative of the active, inactive and reset states, respectively.

The four distinct operating configurations A, B, C and D are defined as follows:

configuration A, in which the first transformation block PC1 is in the active state (PC1ac) and the second transformation block PC2 is in the inactive state (PC2nac);

configuration B, in which the first transformation block PC1 is in the refresh state (PC1res) and the second transformation block PC2 is in the active state (PC2ac);

configuration C, in which the first transformation block PC1 is in the active state (PC1ac) and the second transformation block PC2 is in the reset state (PC2res);

configuration D, in which the first transformation block PC1 is in the inactive state (PC1nac) and the second transformation block PC2 is in the active state (PC2ac);

In FIG. 4 is also illustrated, by arrows representative of the transitions or commutations between the various operating configurations, one possible development of the controller device 50. According to this operational example, the controller device 50 initially assumes configuration A (in which the first transformation block PC1 is active) and following the reaching of the limit value by one of the regulating signals of the first transformation block PC1 a transition (ENDRNG1′) towards operating configuration B takes place in which the second transformation block PC2 is activated. From operating configuration B the controller device 50 may bring itself into operating configuration C, if also a regulating signal of the second transformation block PC2 reaches the corresponding limit value (transition ENDRNG2′). Alternatively, in the case where the first transformation block PC1 reaches the end of reset, in the instant of time preceding the reaching of the limit value for the second transformation block PC2, the controller device 50 develops towards configuration D (transition ENDRES1) in which the second block PC2 is still in the active state.

From configuration C, in the case in which one of the first transformation block PC1 regulating signals reaches the corresponding limit value, the controller device 100 performs a transition (ENDRNG1″) towards configuration B, in such a manner as to initiate the reset procedure.

Starting from configuration C, in the case in which the first event to occur is that of the termination of the reset procedure for the second transformation block PC2, a transition (ENDRES2) towards operating configuration A occurs. Starting from configuration D, when one of the regulating signals of the second transformation block PC2 reaches the limit value, the controller device 50 develops towards configuration C (transition ENDRNG2).

It is observed that, advantageously, each time the limit value for one of the blocks is reached, the changeover towards another operating configuration occurs, by which the transformation block, for which the reset procedure is not necessary, is brought into the active state. Furthermore, advantageously, at the end of the reset procedure in relation to one of the two blocks, the controller device 100 does not carry out another operating configuration transition, but continues to employ the block which is already to be found in the active state, for matching.

In reference also to FIG. 1 and considering configurations A and C, it is observed that the first transformation block PC1 implements a control of the polarisation SOPin of the optical input signal Sin providing a first optical output signal S1 to the first output 1, the state of polarisation SOP1 of which depends on the polarisation at the second output OU and on the transformation introduced by the second block PC2. In particular, in configuration C, the second transformation block PC2 rewind procedure is alerted by the first transformation block PC1 as an additional variation to the polarisation state of the signal S1 at the first output 1. Analogously, considering configurations B and D it is observed that the second transformation block PC2 implements a polarisation control transforming the state of polarisation SOP1 of the signal S1 present at the second input 2, in a manner which is dependent on the state of polarisation SOPin of the optical input signal Sin at the first input INP and on the transformation introduced by the first transformation block PC1. In configuration B, the first transformation block PC1 reset procedure is alerted by the second transformation block PC2 as an additional variation in the state of polarisation of the first optical output signal S1 present at the first output 1.

For the sake of completeness, the operation of the controlled system 100, with reference to the feedback method, will now be described in the following.

The optical input signal Sin, having a polarisation which is variable between all the possible states of polarisation, is fed into the first input INP of the controller device 50. At the second output port 5 of the polarisation beam splitter PSD is present an optical output signal Sopt having a linear polarisation state imposed by the beam splitter PSD itself. It is observed that in this case, wherein the controller device 50 is of the any-to-any type, with the scope of controlling the polarisation of the optical output signal Sopt at the second output port 5, no particular orientation of the beam splitter PSD with respect to the variable birefringence elements included within the polarisation transformer PT is required.

According to the example described, at the first output port 4 of the splitter PSD is sent that portion of the second optical output signal Sou present at the second output OU, which has a polarisation perpendicular to that which is characteristic of the splitter PSD. This portion of the second optical output signal Sou constitutes the optical feedback signal Sofb which is sent to the measuring device MS from the first output port 4. Through the photo-detector PHD, the measuring device MS carries out an electrical conversion of the optical signal received and measures (using the power meter PM) the electrical power associated with the signal emerging from the photo-detector PHD thus providing the analogue electrical feedback signal Sfb.

Such electrical feedback signal Sfb is, therefore, sent to the control and processing stage CB which performs a conversion from analogue to digital (through the A/D converter) thus supplying corresponding digital data over the digital line SL (for example, in serial mode). These digital data are received from the processing unit PU which processes them in order to obtain the regulating signals of each of the variable birefringence elements PCa1-PCc2, so as to permit the device to carry out the transitions between the various configurations A-D, to which the various operative states assumable by the first and second transformation blocks PC1 and PC2 correspond.

With reference to configuration A, the processing unit PU brings the second transformation block PC2 into the inactive state and brings the first transformation block PC1 into the active state, in such a manner as to be able to match the polarisation variations of the optical input signal Sin making use of such first block PC1 alone. The regulating signals sent to the second transformation block variable birefringence elements PCa2-PCc2 are maintained constant over time, whilst those sent to the first transformation block PC1 variable birefringence elements PCa1-PCc1 may vary over time in such a manner as to match the polarisation variations of the optical input signal Sin.

For the generation of the regulating signals which act on the active transformation block (i.e. the first block PC1, according to the example), the processing unit PU may operate in accordance with various possible control criteria. For example, the processing unit generates regulating signals which vary in such a manner as to minimise the output power of the first output port 4 of the band splitter PSD and, hence maximise the power present at the second output port 5 of the splitter itself.

The maximisation of the power at the second output port 5 ensures that the polarisation transformer PT operates in such a manner as to orient the polarisation SOPou of the signal at the second output OU in a manner parallel to the linear polarisation imposed by the polarisation beam splitter PSD.

Preferably, for carrying out the power control, the processing unit PU operates by the technique denominated within the sector by the term “dithering”, but other suitable control techniques may be used. For example, the situation is considered wherein at any certain time point t′, voltage regulating signals having the actual values V1, V2 V3 are applied to the variable birefringence elements PCa1-PCc1 of the first transformation block PC1. At a time point t″ subsequent to time point t′, the processing unit PU generates digital dithering signals which are converted into analogue signals by the D/A converter and are amplified by the drive stage DRIV, in such a manner as to produce commensurate dithering voltage signals. Such dithering voltage signals fed to the variable birefringence elements PCa1-PCc1 constitute the small variations in voltage around the actual values V1, V2, V3.

The dithering voltage signals induce power variations in the optical feedback signal Sofb present at the first output port 4 of the beam splitter PSB which are measured by the measuring device MS. The processing and control stage CB, obtains the electrical feedback signal Sfb arising from the measurement and consequently varies the regulating signals to be fed to the variable birefringence elements PCa1-PCc1, in such a manner as to maximise the power to the second output port 5 of the beam splitter PSD.

It is observed that, advantageously, the electromagnetic radiation associated with the optical input signal Sin is at a wavelength used for optical telecommunications such as, for example, a wavelength comprised within the interval 800 nm-1700 nm. Preferably, the radiation used has a wavelength comprised within the interval 1200 nm-1700 nm or, more preferably, comprised within the interval 1400-1700 nm.

The Applicant has carried out computer simulations verifying the behaviour of a controlled system analogous to the device 100 shown in FIG. 1 and described above. Unlike that shown in FIG. 1, instead of a polarisation beam splitter PSD a linear polariser having the corresponding second input 3 optically coupled to the second output port OU and an output coupled to an input port of an optical coupler has been considered. The optical coupler has a corresponding output optically coupled to the second output port 5 of FIG. 1 and an additional output optically coupled to the first output port 4. In this simulation, matching of the polarisation of the signal Sopt present at the second output port 5 has been carried out in such a manner as to maximise the optical power of the optical feedback signal Sofb present at the first output port 4.

FIGS. 5A, 5B and 5C show some of the results of such simulations. Curve C1 of FIG. 5A shows the time course of the power present at the second output port 5 of the controlled system 100 when no matching is being carried out, i.e. when both the first transformation block PC1, and the second transformation block PC2 are in the inactive state.

Curve C2 shows the behaviour over time of the power at the same second output port 5 when the controller device 100 is activated and is such as to carry out the matching of the optical output signal Sopt present at the second output port 5. In particular, curves C1 and C2 diagram the power Pout of the optical output signal Sopt normalised to the value of the power Pin of the optical input signal Sin, and expressed in dB. The time t represented on the abscissas axis shown in FIGS. 5A, 5B 5C is expressed by using a unit of time corresponding to an elementary time interval substantially equal to the time necessary for the acquisition by the processing unit PU, of the data supplied by the measuring device MS, to the calculation of the digital regulating signals and, to the corresponding variations of the voltage regulating signals fed to the first and second transformation blocks PC1 and PC2.

FIGS. 5B and 5C show the trends of the regulating signals applied to the first transformation block PC1, and to the second transformation block PC2, respectively. Each regulating signal is indicated by the reference representative of the corresponding variable birefringence element PCa1-PCc2. The trends of the regulating signals represented in FIGS. 5B and 5C are indicative of the trends of corresponding voltage signals, but the values which they assume (represented in a dimensionless interval of values 0-400) do not constitute actual voltage values to be applied to the polarisation converter elements.

For example, FIGS. 5B and 5C are observed starting from the time point t1. Subsequent to time t1 the first transformation block PC1 is in the active state and performs matching. The first transformation block PC1 regulating signals show the oscillations or vibrations typical of the dithering technique, up to about the time t2.

Within the same interval of observation, t1-t2, the second transformation block PC2 is in a reset state and, in particular, the rewind of the first variable birefringence element PCa2 is carried out, bringing the corresponding value to a value equal to that of around half of the 0-400 scale.

At time point t2, the second variable birefringence element PCB1 of the first transformation block PC1, reaches a limit value and hence the procedure for its rewind commences. Starting from time point t2, polarisation matching is entrusted to the second transformation block PC2.

The trend of the regulating signals for the other time points subsequent to t2 represented in the figures correspond to the transitions between active states and reset states, and it is apparent on the basis of that described above.

As observed from curve C1, a wide fluctuation in the power present at the second output port 5 in the case of the non activation of matching, resulting from a considerable variation in the polarisation of the optical input signal Sin has been considered for this simulation. Curve C2 demonstrates that with the regulating signals of FIGS. 5B and 5C generated in accordance with the invention, the power at the second output port 5 has limited and acceptable oscillations.

Furthermore, curve C2 emphasises how the control of the power at the second output port 5 is carried out efficiently even when the attainment of a limit value for one of the variable birefringence elements of the controller device 50 occurs.

The Applicant has observed that by using polarisation converter elements having a response time of around 35 μs, it is possible to match variations in optical input signal polarisation Sin having a frequency comprised of between 0 and 100 Hz with satisfactory performances. Such values are compatible with the demands of the optical telecommunications sector. By using converter elements having inferior response times to that indicated above it is possible to match variable polarisations with frequencies of some KHz.

It is noted that the controller device and the control method achieved in accordance with the invention allow the attainment of substantially continuous polarisation control which is not affected by the rewind procedure in any considerable manner. I.e., the device of the invention offers control which may be defined as end-less type.

It is also important to note that the controller device 50 in accordance with the invention is easy to manufacture, also because no particular reciprocal orientation between the polarisation converter elements which appertain to the first transformation block (elements PCa1-PCc1), and those which appertain to the second transformation block (elements PCa2-PCc2) is necessarily required. Furthermore, the control device 50 may be achieved in a simple manner by arranging two polarisation transformation blocks, already available on the market, in series.

According to one embodiment of the invention, alternative to that of FIG. 1, the controller device 50 may be achieved such as to perform fix-to-any type transformations.

FIG. 6 schematically shows the structure of the single polarisation transformer PT utilisable in the case in which the controller device 50 is of the fix-to-any type. In FIG. 6 and in the following figures, the same numerical references are used in order to indicate identical or analogous elements.

In this case, the first transformation block PC1 includes only two converter elements PCa1, PCb1 oriented reciprocally in a manner analogous to that described for those of FIG. 1. The first converter element PCa1 is oriented with respect to the known polarisation of the optical input signal Sin in such a manner as to be able to bring about a non-null transformation. Therefore, the presence of the two converter elements PCa1, PCb1 ensures the possibility of bringing about a fix-to-any transformation. The second transformation block PC2 is an any-to-any block (including three converter elements PCa2, PCb2 and PCc2) suitable for receiving any type of polarisation at the second input 2.

According to another embodiment of the invention, alternative to those preceding, the controller device 50 may be achieved in such a manner as to carry out an any-to-fix control.

FIG. 7 schematically shows the structure of the single polarisation transformer PT utilisable in the case in which the controller device 50 is of the any-to-fix type. In this case, the first transformation block PC1 (of any-to-any type) includes three converter elements PCa1, PCb1, PCc1 oriented reciprocally in an analogous manner to that described for those of FIG. 1.

The second transformation block PC2 includes only two polarisation elements PCa2 and PCb2 and is an any-to-fix block, i.e. such as to transform any polarisation into a polarisation of fixed output.

The operation of the controller devices in the fix-to-any (transformer PT of FIG. 6) and any-to-fix (transformer PT of FIG. 7) cases is analogous to that described previously for the any-to-any type controller device 50 with reference to FIG. 4.

In controlled system 100 in the version in which it uses the any-to-fix type controller device 50 (the transformer PT of which is partly shown in FIG. 7) may be advantageously applied for polarisation control in a coherent optical receiver. In this case, the polarisation sensitive device PSD and the measuring device MS of FIG. 1 are substituted with the devices shown in FIG. 8. According to this embodiment, the second optical output signal Sou (henceforth, called controlled optical signal Sou), present at the second output OU, carries the information content of the received signal coincident with the input signal Sin and having a frequency fsig. The signal Sin is a signal which is propagated, for example, along a fibre optic line (not shown) such as to modify its state of polarisation. The controlled system 100 has the input INP connected to one extremity of the fibre optic line and the second output port 5 is connected to an apparatus suited to the completion of coherent reception (not shown), entirely conventional in itself.

In such a case, the polarisation sensitive device PSD includes a local laser LS1 in order to generate a local optical signal at a local frequency flo, optically connected to a first optical coupler OC1. The optical coupler OC1 allows coupling, on a single first optical output waveguide G1, the local optical signal and the controlled optical signal Sou, fed into the input port 3 and hence to the second optical waveguide G2. The optical waveguide G1 is connected to a second optical coupler OC2 which allows sending a part of the optical signal obtained from the combination of the controlled optical signal Sou and from that generated locally, over the first output port 4.

The part of the signal on the first output port 4 constitutes the optical feedback signal Sofb to be fed to the measuring device MS. According to this embodiment of the invention, the measuring device MS includes, besides the photodiode PHD and the power meter PM, also an electrical filter F, having a frequency response substantially centred on the value fsig-flo (the difference between the two frequencies) in such a manner as to capture that part of the electrical signal emerging from the photodiode PHD corresponding to the collision between the optical signal produced by the local laser LS1 and the controlled optical signal Sou fed to the input port 3. As is known, the power of such a collision signal, which carries the information form the signal received, is maximal when the polarisations of the signal received (in this case, the controlled optical signal Sou) and that of the local laser LS1 are aligned.

The controlled system 100, allows providing the controlled optical signal Sou, having a substantially stable polarisation, i.e. such as to satisfy the requirements of coherent demodulation, to the second output OU connected to the input port 3. In particular, the control and processing stage CB generates regulating signals, which bring about the maximisation of the power associated with the signal filtered by filter F.

According to another possible application, the controlled system 100 may be used for the compensation of polarization mode dispersion PMD. For example, the controlled device 100 may be placed at the end of a fibre optic which may have caused dispersion in the polarisation of digital signals. For this application the controller device 50 is used in the any-to-any version and, with reference to FIG. 1, the polarisation sensitive device PSD is achieved by a high birefringence fibre optic HiBi (not shown) placed between the second output OU and the second output port 5.

As is known to those skilled in the art, the high birefringence fibre optic HiBi has a compensation role for the dispersion introduced by the fibre optic, along which the digital signal is propagated.

At the end of the length of high birefringence fibre HiBi is inserted an optical coupler which captures part of the signal which has crossed the fibre HiBi in order to send it over the first output port 4 and, hence, make the optical feedback signal Sofb available.

For this application, the measuring device MS includes a conventional degree of polarisation (DOP) meter, which allows sending an electrical signal to the control and processing stage CB indicative of the DOP, that is of the percentage of the power associated with the optical feedback signal which is polarised with respect to the total power.

The control and processing stage CB generates regulating signals aimed at maximising the DOP parameter. As is known, the maximisation of the DOP parameter allows reducing the distortion of the digital signals associated with the dispersion of polarisation. Alternatively to the DOP meter, any other device able to provide a measurement indicative of the distortion of the signal present within the high birefringence fibre HiBi may be used.

According to one embodiment of the invention, alternative to those preceding, the controller device 50 may also include one or more additional polarisation transformation blocks (arranged in series to the transformer PT and analogous to the first block PC1 and to the second block PC2) which may be brought into the active state if both the first PC1 and the second PC2 blocks find themselves in the reset state due to the attainment of the limit value for the corresponding regulating signals. In the particular case of three blocks, the operation of the controller device is, for example, the following:

for polarisation control, only one block at a time is brought into the active state;

when the limit value of a first transformation block polarisation converter element regulating signal is reached, the second transformation block is brought into the active state;

when the limit value of this second block regulating signal is reached and the first block has finished rewind, the first block is brought into the active state;

if instead the limit value of the second block regulating signal is reached and the first block has not finished rewind, the third block is brought into the active state.

It is observed that although in the previous discussion the controller device 50, in its various versions (any-to-any, fix-to-any, any-to-fix), has been described as inserted within a feedback system, it is also possible that such a device performs polarisation control not based on feedback signals. For example, it is possible to envisage varying the polarisation in order to obtain the second optical output signal Sou on the basis of measurements carried out on the optical input signal Sin.

1-34. (canceled)

35. An optical signal polarisation control method, comprising the steps of:
feeding an optical input signal to a first polarisation transformation block for providing a corresponding first optical output signal;
feeding the first optical output signal to a second polarisation transformation block for providing a corresponding second output signal; and
providing to said blocks regulating signals variable within limited operating intervals and such as to permit said blocks to assume the following alternative configurations:
at least one configuration wherein one block between the first and the second blocks assumes an active state in which said configuration performs a polarisation transformation that is variable over time, and the other block assumes an inactive state in which said configuration carries out a polarisation transformation that is substantially constant over time, or
at least one additional configuration wherein one block between the first and the second blocks is in the active state and the other block is in a reset state in order to carry out a rewind operation wherein at least one of the corresponding regulating signals is made to assume a value within the corresponding limited interval.

36. The method according to claim 35, wherein:
said at least one configuration comprises the following alternative configurations: a first configuration, wherein the first block assumes the active state and the second block assumes the inactive state, and a second configuration, wherein the first block assumes the inactive state and the second block assumes the active state;
said at least one additional configuration comprises the following alternative configurations: a second configuration wherein the second block is in the active state and the first block in the reset state, and a third configuration wherein the first block assumes the active state and the second block assumes the reset state.

37. The method according to claim 35, wherein at least one of said first and second output signals has a polarisation state that is variable between all the possible states of polarisation.

38. The method according to claim 35, further comprising the steps of:
reaching a limit value by at least one regulating signal of one of said blocks; and
generating at least one regulating-reset signal for bringing one of said blocks, for which the reaching of the limit value has occurred, into the reset state.

39. The method according to claim 38, further comprising the steps of:
completing said rewind operation for one of said blocks which has assumed the reset state; and
generating at least one regulating-deactivation signal in order to bring one of said blocks from the reset state into the inactive state.

40. The method according to claim 35, comprising one of the following steps:
transforming the input signal into the second output signal by carrying out any-to-any type polarisation transformations;
transforming the input signal into the second output signal by carrying out any-to-fix type polarisation transformations; or
transforming the input signal into the second output signal by carrying out fix-to-any type polarisation transformations.

41. The method according to claim 35, comprising the steps of:
generating a feedback signal starting from the second output signal; and
processing said feedback signal and generating the regulating signals to be fed to said blocks.

42. The method according to claim 41, comprising a measurement step, carried out on the basis of an optical feedback signal which is dependent on said second output signal, the measurement step returning the feedback signal correlated with a quantity which is associated with the optical feedback signal.

43. The method according to claim 42, wherein said quantity is an optical power associated with the optical feedback signal and comprising a generation step of the regulating signals in such a manner as to control said optical power.

44. The method according to claim 43, additionally comprising generation steps of the dithering type regulating signals for inducing variations in said polarisation transformations carried out by one of said blocks in the active state.

45. A polarisation control device, comprising:
a first adjustable block for transforming the polarisation of an optical input signal and providing a corresponding first optical output signal;
a second adjustable block distinct from the first block for receiving the first output signal as input and transforming the polarisation of the signal, thus providing a corresponding second optical output signal;
a control stage for providing to said blocks regulating signals varying between limited operating intervals, adapted to bringing the device into the following alternative configurations:
at least one configuration wherein one block between said first and second blocks, assumes an active state in which said configuration performs a polarisation transformation that is variable over time, and the other block assumes an inactive state in which the configuration carries out a polarisation transformation, that is substantially constant over time, or
at least one additional configuration wherein, one block between said first and the second blocks is in the active state and the other block is in a reset state wherein at least one of the corresponding regulating signals is induced by the control stage to assume a value within said limited interval.

46. The device according to claim 45, wherein:
said at least one configuration comprises the following alternative configurations: a first configuration wherein the first block assumes the active state and the second block assumes the inactive state, and a second configuration wherein the first block assumes the inactive state and the second block assumes the active state;
said at least one additional configuration comprises the following alternative configurations: a second configuration wherein the second block is in the active state and the first block is in the reset state, and a third configuration wherein the first block assumes the active state and the second block assumes the reset state.

47. The device according to claim 45, wherein said blocks are such as to carry out polarisation transformations such that at least one out of said first and second output signals has a polarisation that is variable between all the possible states of polarisation.

48. The device according to claim 45, wherein said control stage is such as to generate at least one regulating-reset signal for bringing one of said blocks into the reset state following the reaching, by one of the corresponding regulating signals, of a limit value of its own operating interval.

49. The device according to claim 45, wherein at least one of said first and second blocks is realised according to one of the following typologies: any-to-any, fix-to-any, or any-to-fix.

50. The device according to claim 49, wherein said first and said second blocks are of the any-to-any type, such that the first and the second blocks may accomplish any-to-any type overall polarisation transformations.

51. The device according to claim 49, wherein said first block is of the fix-to-any type and said second block is of the any-to-any type, in such a manner that the first and the second blocks may accomplish fix-to-any type overall polarisation transformations.

52. The device according to claim 49, wherein said first block is of the any-to-any type and said second block is of the any-to-fix type, in such a manner that the first and the second blocks may accomplish any-to-fix type overall polarisation transformations.

53. The device according to claim 45, wherein the first and the second blocks respectively, comprise a first and a second plurality of optical polarisation conversion elements.

54. The device according to claim 53, wherein said first and said second pluralities comprise at least one corresponding first optical element having a fixed principal birefringence axis and a birefringence that is variable on the basis of a corresponding first regulating signal generated by said control stage.

55. The device according to claim 54, wherein said at least first optical element is a fibre optic squeezer.

56. The device according to claim 54, wherein said at least first optical element is a liquid crystal element.

57. The device according to claim 53, wherein at least one of said first and said second pluralities comprises at least one second optical element having birefringence and having a principal birefringence axis that is variable on the basis of a corresponding second regulating signal generated by said control stage.

58. A controlled polarisation system comprising:
a polarisation controller device according to claim 45,
a polarisation sensitive device provided with:
an optical input port for receiving the second output signal;
an optical output port for making available an output signal having a polarisation state that is dependent on said second output signal; and
an optical feedback port for making available an optical feedback signal having a polarisation state which is dependent on said second output signal.

59. The system according to claim 58, wherein said control stage comprises a processing unit such as to process electrical signals obtained from said optical feedback signal for generating the regulating signals.

60. The system according to claim 59, further comprising a measuring device for receiving the optical feedback signal and providing an electrical feedback signal to be fed to the control stage, and correlated with a quantity associated with the optical feedback signal.

61. The system according to claim 60, wherein said quantity is the power associated with the optical feedback signal and said control stage generates regulating signals in such a manner as to maximise the optical power of the emerging signal present over said optical output port.

62. The system according to claim 60, wherein said measuring device comprises a photo-detector for converting the optical feedback signal into a corresponding electrical signal.

63. The system according to claim 58, wherein said polarisation sensitive device comprises a polarisation beam splitter optically coupled to said optical input port and having two outputs optically coupled to the optical output port and to the optical feedback port.

64. The system according to claim 58, wherein said polarisation sensitive device comprises a polariser which is optically coupled to the optical input port and such as to transmit a selected part of the second output signal having preset polarisation over a corresponding output.

65. The system according to claim 64, further comprising a first optical coupler, comprising a corresponding input such as to receive said selected part and send a portion of said selected part over a first output optically coupled to the optical feedback port and a corresponding second output optically coupled to the optical output port.

66. The system according to claim 58, such as to carry out coherent reception, and wherein said polarisation sensitive device comprises a second optical coupler provided with:
an additional input port in order to receive a local optical signal; and
a common output to which the local optical signal and the second output signal are sent in such a manner as to obtain a resultant optical signal which is dependent on the state of polarisation of said second output signal, said common output being optically coupled to the optical output port and to the optical feedback port.

67. The system according to claim 60, such as to perform compensation for polarisation mode dispersion and wherein said polarisation sensitive device comprises a high birefringence fibre in which the second optical output signal is propagated, and said measuring device comprises a device which is able to provide an electrical feedback signal which is representative of the distortion of the second optical signal which is propagated within said fibre.
